(19) United States
(12) Patent Application Publication
(10) Pub. No.: US 2012/0187106 A1
(43) Pub. Date: Jul. 26, 2012

(54) PHOTOVOLTAIC HEATER

(75) Inventor: Hana Ashkenazy, Tallahassee, FL (US)

(73) Assignee: EDS USA INC., Tallahessee, FL (US)

(21) Appl. No.: 13/433,322

(22) Filed: Mar. 29, 2012

Related U.S. Application Data
(63) Continuation-in-part of application No. PCT/IB2010/055872, filed on Dec. 16, 2010.
(60) Provisional application No. 61/286,813, filed on Dec. 16, 2009.

(51) Int. Cl. H05B 3/02; H05B 3/78

(52) U.S. Cl. 219/438; 219/507

(57) ABSTRACT

A photovoltaic cell array, one or more heating elements, and a maximum power point tracking circuit configured to track the maximum power point of the photovoltaic cell array and to provide that maximum power collectively to the heating element(s).

### FIELD AND BACKGROUND OF THE INVENTION

The present invention relates to the field of solar energy, and, particularly, relates to photovoltaic array heating at maximum power for changing incident, solar radiation conditions.

It is known that in non-electrical, solar-heating panels, water is heated by flowing through heating tubes absorbing radiant solar energy; free flow through the tubes is essential to the proper performance of the panels. In cold climates in which ambient air temperatures drops below the freezing point of water, there is likelihood that the water in the tubes will freeze and consequently will rupture the heating tubes. Therefore, there is a need for a durable solar heating system operative in freezing weather conditions.

U.S. Pat. No. 5,293,447 discloses an electrical solar heating system operative on photovoltaic arrays configured to adjust either the resistive load or the power generating characteristics of the photovoltaic array to maximize power transfer efficiency. Load resistance is altered by way of switching circuitry that engages a particular heating element or combination of elements to approximate the resistance associated with point of maximum power point. The shortcoming is that each load resistance element has a discrete resistance making it nearly impossible to achieve the target resistance associated with point of maximum power point, consequently the heaters will not be operating at the maximum power at which the panels are capable of producing, thereby wasting precious solar power. Furthermore, the required plurality of heating elements adds to capital and maintenance costs.

Therefore, there is a need for a PV cell array capable of powering standard “off-the-shelf” electrical heaters, at maximum power for given solar irradiance conditions.

### SUMMARY OF THE INVENTION

The present invention is a photovoltaic heating system responsive to changing incident solar radiation. According to the teachings of the present invention there is provided a photovoltaic heater responsive to fluctuations in incident solar radiation intensity including: (a) a photovoltaic cell array; (b) at least one primary heating element; and (c) a maximum power point tracking circuit configured to track a point of maximum power of the photovoltaic cell array and to provide the maximum power collectively to the at least one heating element.

According to a further feature of the present invention, the system also includes a medium, for example water, oil or air, wherein the at least one heating element is at least partly immersed in order to heat the medium.

According to a further feature of the present invention, the system also includes a switch mechanism configured to reversibly connect the heating element to an electric power grid and to reversibly disconnect the heating element from the photovoltaic cell array.

According to a further feature of the present invention, the system also includes auxiliary heating element; and a grid switch, the grid switch configured to reversibly couple the auxiliary heating element to an electric power grid to supplement heating by the at least one primary heating element.

According to a further feature of the present invention, the system also includes a conversion switch in operational connection with the grid switch, the conversion switch configured to reversibly disconnect the primary heating element from the maximum power point tracking circuit when the auxiliary heating element is coupled to the electric power grid, thereby converting the photovoltaic heater into a conventional heater.

According to a further feature of the present invention, the maximum power point tracking circuit includes circuitry to convert DC current to AC current.

There is also provided according to the teachings of the present invention, a method of photovoltaic heating including: (a) tracking a point of maximum power of a photovoltaic cell array; and (b) driving a heating element at substantially the maximum power.

According to a further feature of the present invention, is the method also includes immersing at least a portion of the heating element in a medium to heat the medium.

There is also provided according to the teachings of the present invention, a hybrid heating system including: (a) a medium to be heated; (b) a solar powered heating element at least partially submerged in the medium; (c) a photovoltaic power system operationally connected to the solar powered heating element and including: (i) a photovoltaic cell array, and (ii) a maximum power point tracking circuit configured to track a point of maximum power of the array and to provide the power to the solar powered heating element; (d) a grid powered heating element at least partially submerged in the medium; and (e) a grid switch for reversibly connecting the grid powered heating element to an electric power grid.

According to a further feature of the present invention, the system also includes (f) a timer-activated thermostat configured to actuate the grid switch at a selectable time when a temperature of the medium is less than a predefined temperature, thereby automatically augmenting heating of the medium by the solar powered heating element to obtain a desired temperature.

### BRIEF DESCRIPTION OF THE DRAWINGS

The invention is herein described, by way of example only, with reference to the accompanying drawings, wherein:

FIG. 1 is block, pictorial diagram of a photovoltaic heating system of the present invention.

FIGS. 2-3 are combination I-V and Power-Voltage curves for photovoltaic array operating at solar irradiances of 1000 W/m² and 600 W/m², respectively.

FIGS. 4 and 4A are exemplary topologies for MDPT circuitry employed to output DC and AC current to power a heating element, respectively in the present.

FIGS. 5 through 5D are block pictorial diagrams of the photovoltaic heating system of FIG. 1 including various switching arrangements for coupling to an electric grid.

FIG. 6 is block pictorial diagram of a photovoltaic heating system operative on a photovoltaic power system and an electrical grid simultaneously.

FIG. 7 is block pictorial diagram of a photovoltaic heating system convertible to tradition electric grid heating system.

FIG. 8 is block pictorial diagram of a photovoltaic heating system convertible to tradition electric grid heating system fitted with a timer-thermostat.

FIG. 9 is pictorial diagram of a photovoltaic heating system configured to power a radiator disposed inside a home.

### DESCRIPTION OF THE PREFERRED EMBODIMENTS

The present invention is a photovoltaic heating system responsive to changing incident solar radiation. Specifically, the photovoltaic heating system dynamically delivers maximum power of a photovoltaic cell array to a resistance heating element for any given incident solar radiation. The principles and operation of the method according to the present invention may be better understood with reference to the drawings and the accompanying description.

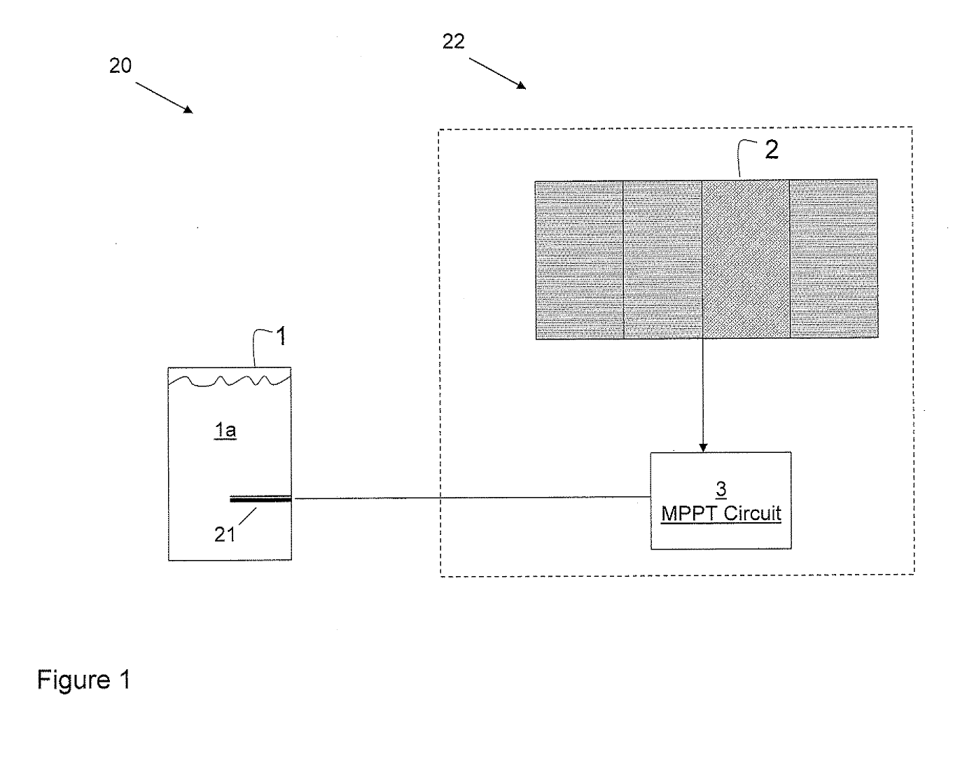

Turning now to the figures, FIG. 1 depicts a non-limiting, preferred embodiment of a photovoltaic heating system, generally designated 20, including a photovoltaic (PV) array 2, a maximum power point tracking (MPPT) circuit 3 to extract maximum power possible from PV array 2 at any given solar irradiance and to convert the voltage associated with the maximum power point to a driving voltage driving a resistance heater 21 immersed inside a medium 1a contained inside a tank 1. Typically, the medium is water, but the medium could be a different fluid, such as air or oil, depending on the intended application of system 20

In embodiments having a plurality of heating elements 21, the electricity received from PV array 2 is distributed amongst the elements 21 so that all the elements 21 together are collectively powered by array 2.

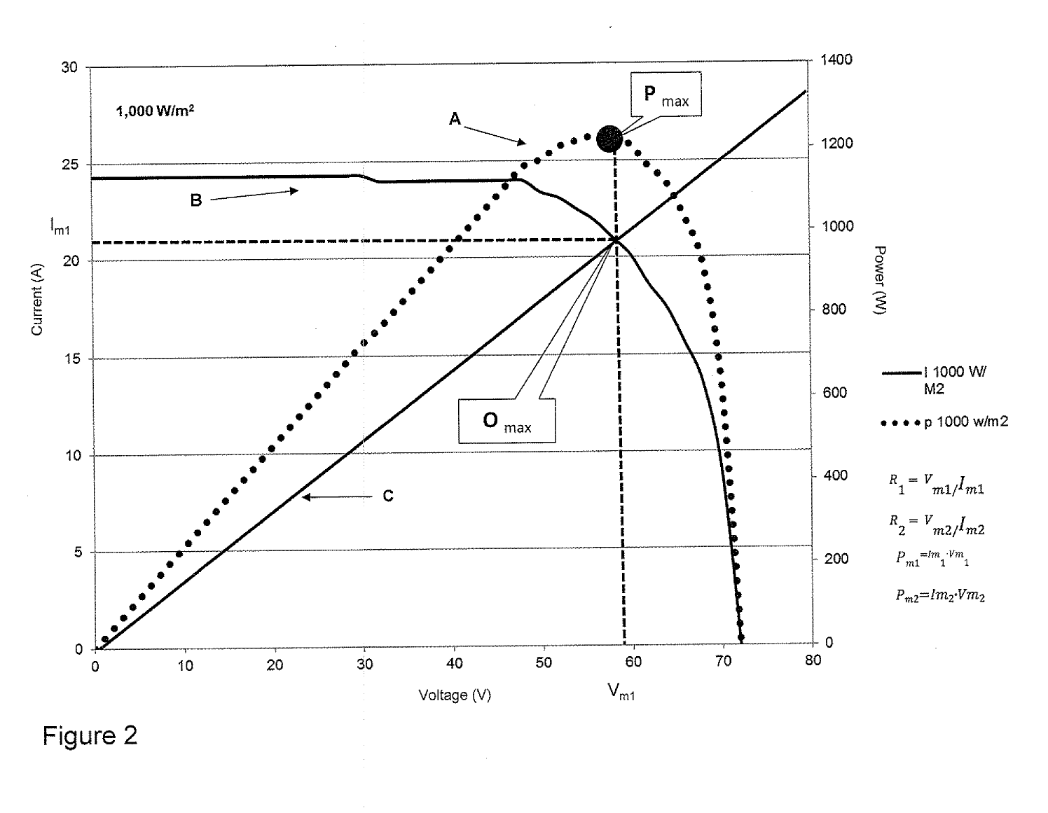

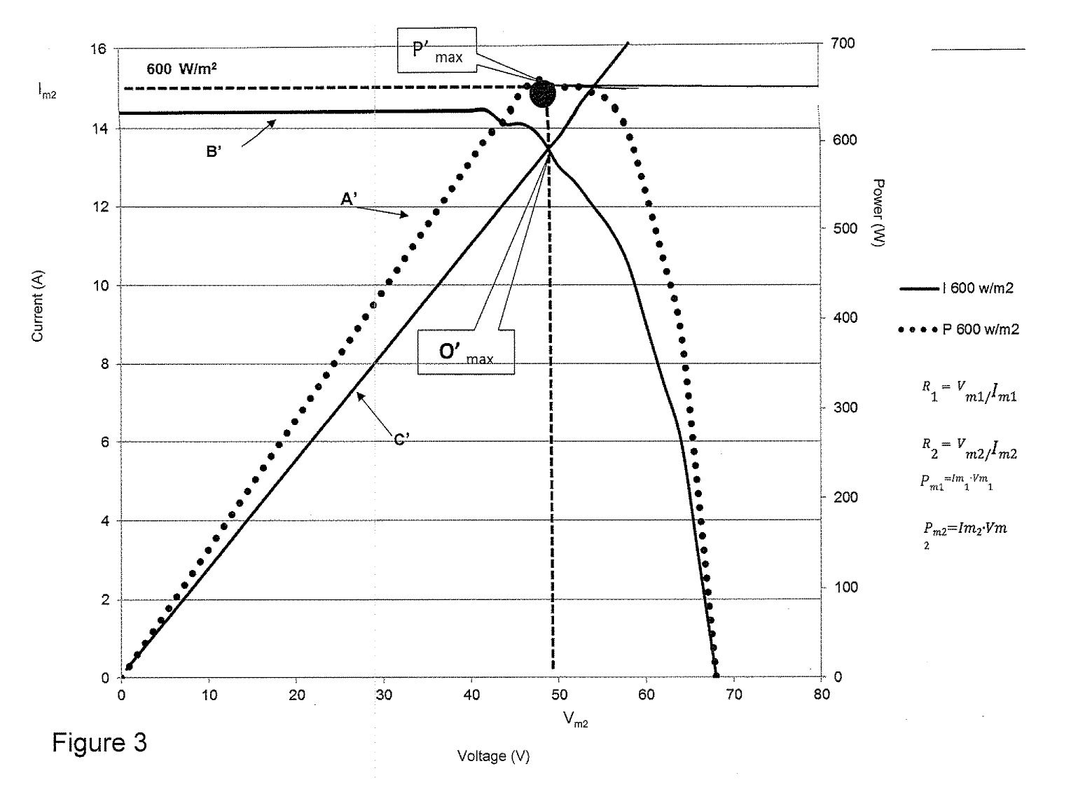

FIG. 2 depicts an I-V curve, A and a P-V curve 13 for an exemplary photovoltaic cell array operating at an incident solar radiation of 1000 W/m₂ in which the maximum power point is represented by point Pₘₐₓ on P-V curve A. The corresponding operating point of this array is represented by point Oₘₐₓ on I-V curve B. Vₘₐₓ is 59 volts and Iₘₐₓ is 22 ampere, and the maximum power derivable from the PV array at the solar radiation intensity of 1000 W/m² is P_{M}=59×22=1298 W. As the incident radiation intensity changes, MPPT circuit 3 converges on a new operating voltage and current associated with a revised maximum power as shown in FIG. 3 in which the incident solar intensity has changed to 600 W/m₂. The revised maximum power is now represented by point P′ₘₐₓ on P-V chart A′. The operating point of this array is represented by point O′ₘₐₓ of I-V curve B′; V′ₘₐₓ is 49 volts and I′ₘₐₓ is about 13.5 ampere leading to a maximum power derivable from the PV array at the solar radiation intensity of 600 W/m² is P′_{M}=49×13.5=661.5 W.

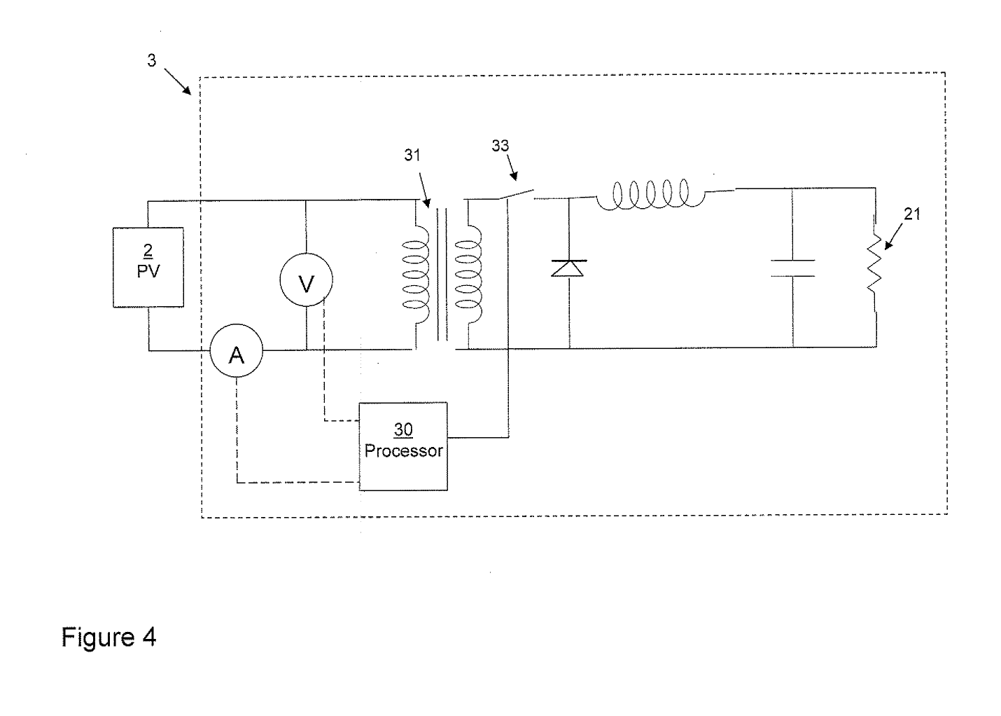

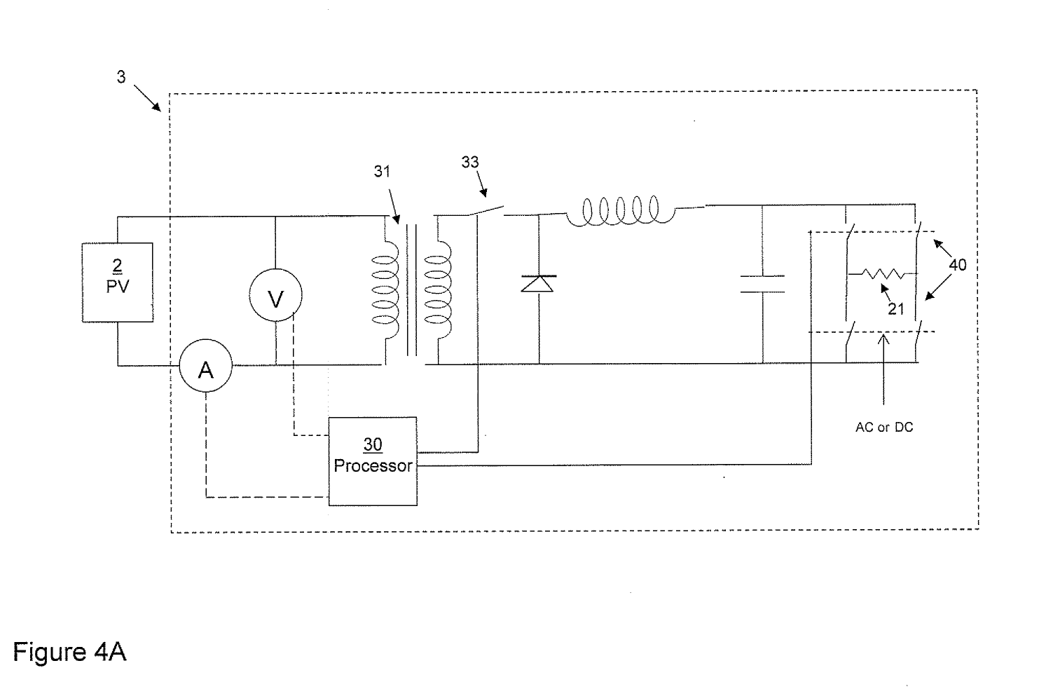

FIG. 4 depicts an exemplary topology for MPPT circuit 3 configured to track the maximum power point and convert the voltage associated with the maximum power point into the drive voltage driving resistance heater 21. MPPT circuit 3 includes switch 33 operatively linked to a processor 30 configured to measure the output voltage and current of PV cell array 2. In a non-limiting, exemplary embodiment, processor 30 causes MPPT circuit 3 to converge on an operating voltage and current associated with the maximum power output of PV cell array 2 by changing a duty cycle of switch 33 by way of Pulse-Width Modulation. Switch 33 is turned on and off at a rate and a duty cycle defined by processor 30 thereby defining an average driving voltage driving resistance heater 21. Resistance heater 21 of a fixed resistance defines an output power according to Pₕₑₐₜₑᵣ=Vₕₑₐₜₑᵣ²/Rₕₑₐₜₑᵣ. The output power (Pₕₑₐₜₑᵣ) equals input power (P_{PV}) provided by PV cell array 2 to heater 21 as defined by the PV operating voltage and current according to P_{PV}=V_{PV}I_{PV}. The input impedance of MPPT circuit 3 is thereby defined according to V_{PV}=I_{PV}R_{PV}→R_{PV}=V_{PV}/I_{PV} or in terms of the I-V diagram, I_{PV}/V_{PV}=1/R_{PV} as denoted on FIGS. 2 and 3 as straight lines C and C′, respectively, for the maximum power points. The output voltage V_{PV} and current I_{PV} are measured at various duty cycles of switch 33, their product determined and compared with previously stored values of PV cell array IV products at previously used duty cycles until the highest product, or power Pₘₐₓ, is identified by processor 30. Once the maximum power Pₘₐₓ, and associated Vₘₐₓ and Iₘₐₓ have been identified, Vₘₐₓ is converted to Vₕₑₐₜₑᵣ by a transformer 31. PV voltages of 50-60 volts are converted to voltages on the order of 160 volts at an efficiency of 95% in a non-limiting, exemplary embodiment. Employing the above noted power equation, it follows that at operating point Oₘₐₓ of FIG. 2 resistance heater 21 of 20 ohms outputs about 160²/20=1285 Watts of power. It should be appreciated that that any circuitry configured to determine the maximum power point and deliver a substantially maximum power is included within the scope of the present invention. MPPT circuit 3 as illustrated in FIG. 4 is only a simple example of one MPPT circuit 3 that is suitable for the present invention. Many other types of MPPT circuits 3 are suitable, as will be clear to those skilled in the art.

Typical PV arrays include 4 panels to produce 800 watts or 6 panels to produce 1200 watts; however, all types of PV arrays and configurations are included also within the scope of the present invention.

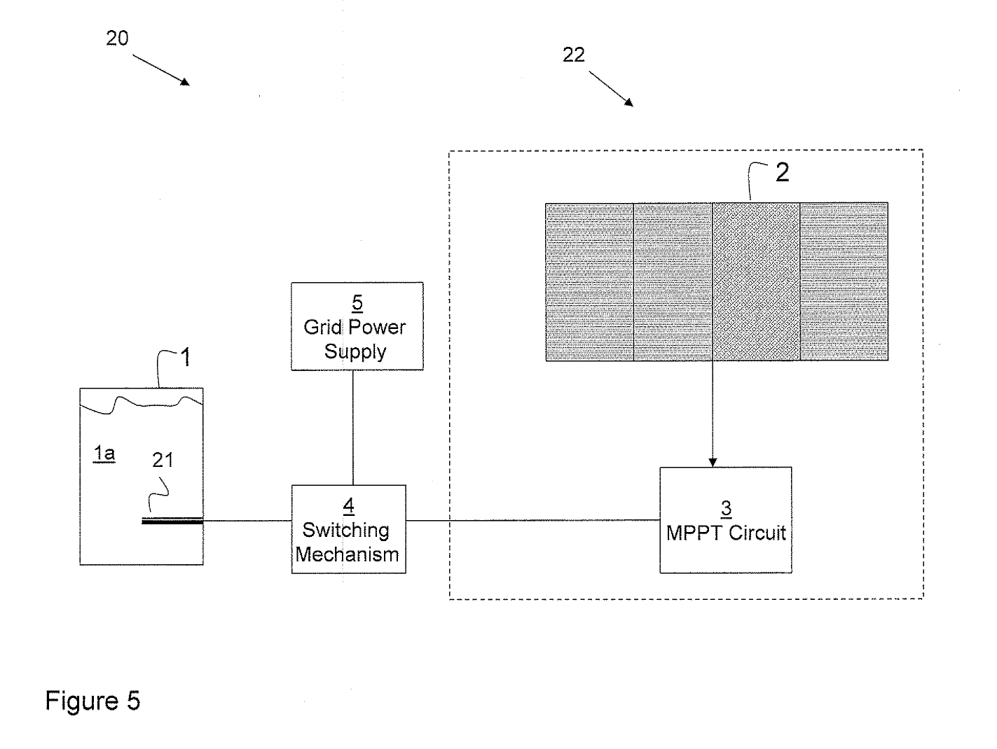

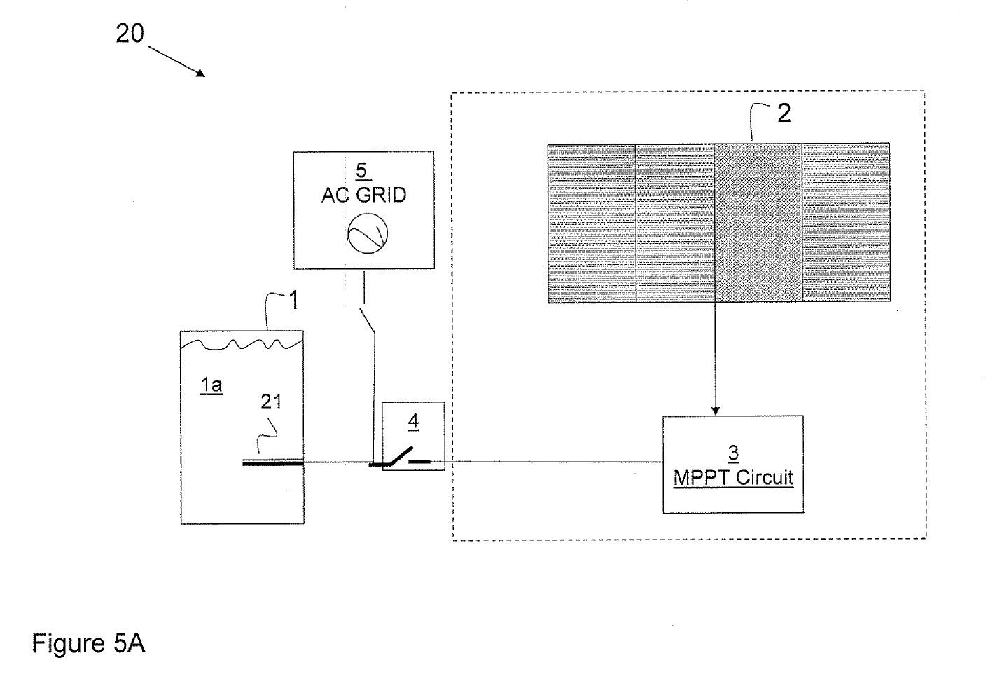

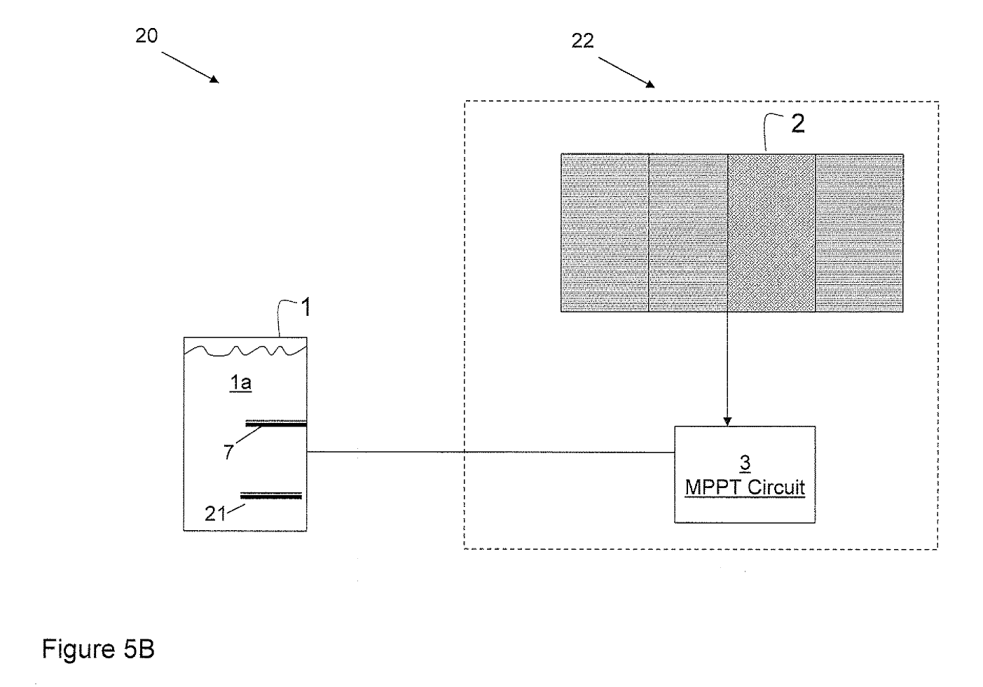

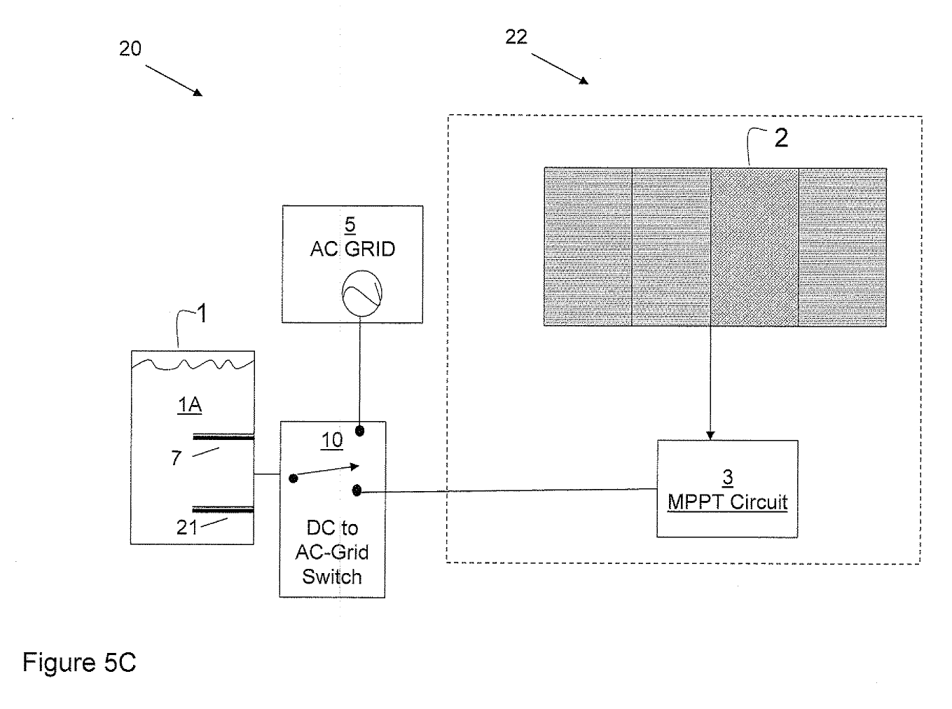

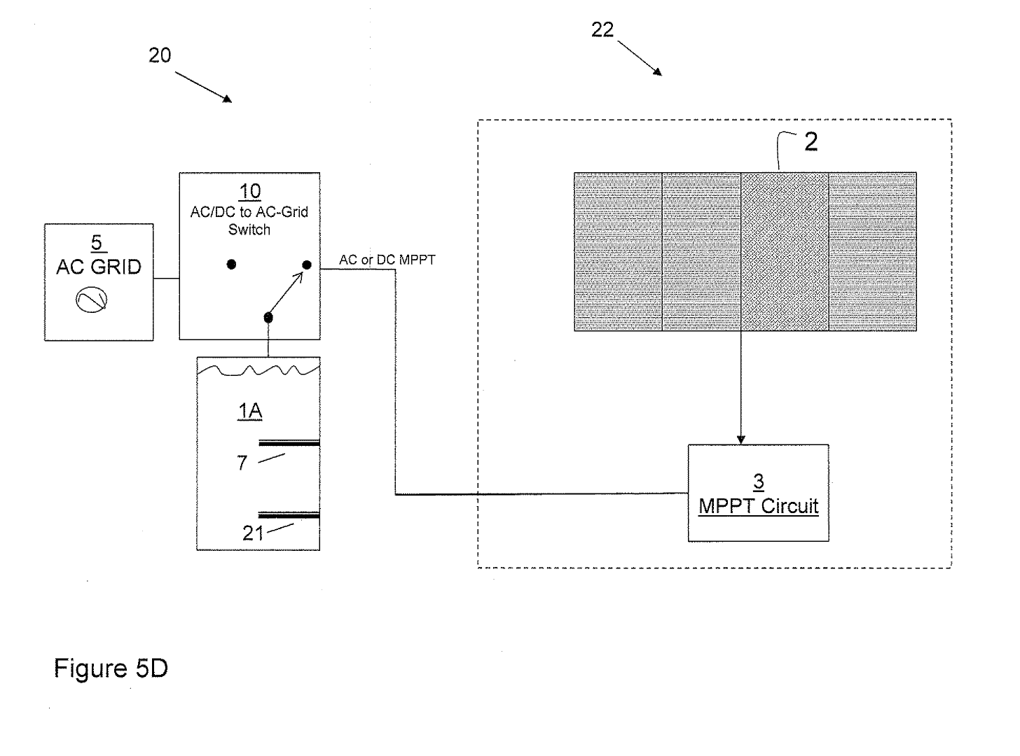

FIG. 4A depicts the circuit topology of FIG. 4 plus bridge circuitry 40 configured to selectably output either DC current generated by PV modules 2 or to convert that DC current to AC current depending on how the switches of bridge circuitry 40 are set by processor 30 as is known to those skilled in the art. It should be noted that any circuitry capable of such functionality as known by those skilled in the art is included within the scope of the present invention. FIG. 5 depicts an embodiment providing auxiliary AC grid heating to augment PV heating. Heating element 21 is operative on both PV power system 22 and a grid power supply 5. During general heating, a switching mechanism 4 assumes a default state connecting PV power system 22 to heating-element 21 and disconnecting heating element 21 from gridded power supply 5. During times in which quick heating is required, switching mechanism 4 disconnects PV power system 22 and connects gridded AC power supply 5. It should be noted that all heating elements employed in the present system are standard “off-the-shelf” models rated between 800-3000 Watt to advantageously heat at voltages supplied by PV power system 22 or by a gridded AC power supply 5. Switching mechanism 4 is implemented as a manual switch, or as a timer-actuated switch, or as a timer-actuated thermostat. It should be further appreciated that heating tanks having any number of immersible heating-elements are also included in the scope of the present invention.

FIG. 5A depicts the switching arrangement of FIG. 5 in which switch 4 is configured to couple heating element 21 to an AC grid non-concurrently with PV power system 22. FIG. 5B depicts an alternative embodiment of the system of FIG. 1 with an auxiliary heating element 7 also powered by PV power system 22.

FIG. 5C depicts an embodiment of the system of FIG. 5B in which both primary and auxiliary heating elements 21 and 7 are selectably coupled to either the PV power system 22 or to AC grid 5 by way of grid switch 10.

FIG. 5D depicts an embodiment analogous to that of FIG. 5C with the grid switch 10 configured to couple primary and auxiliary heating elements 21 and 7 to either AC grid 5 or to PV power system 22 outputting either DC or AC current.

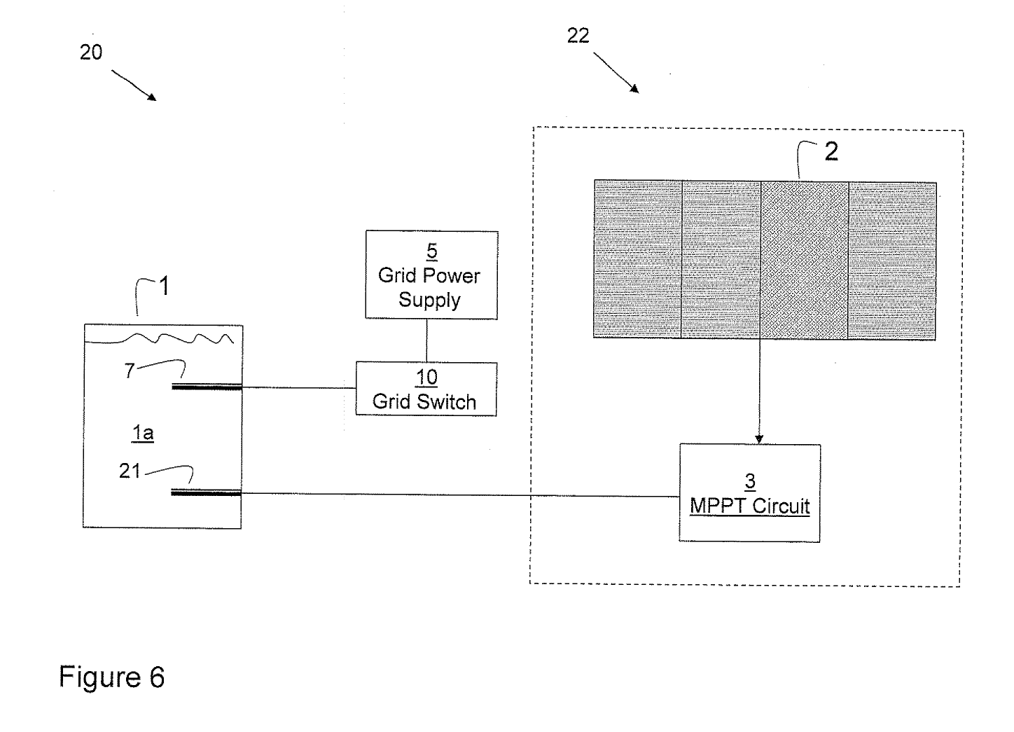

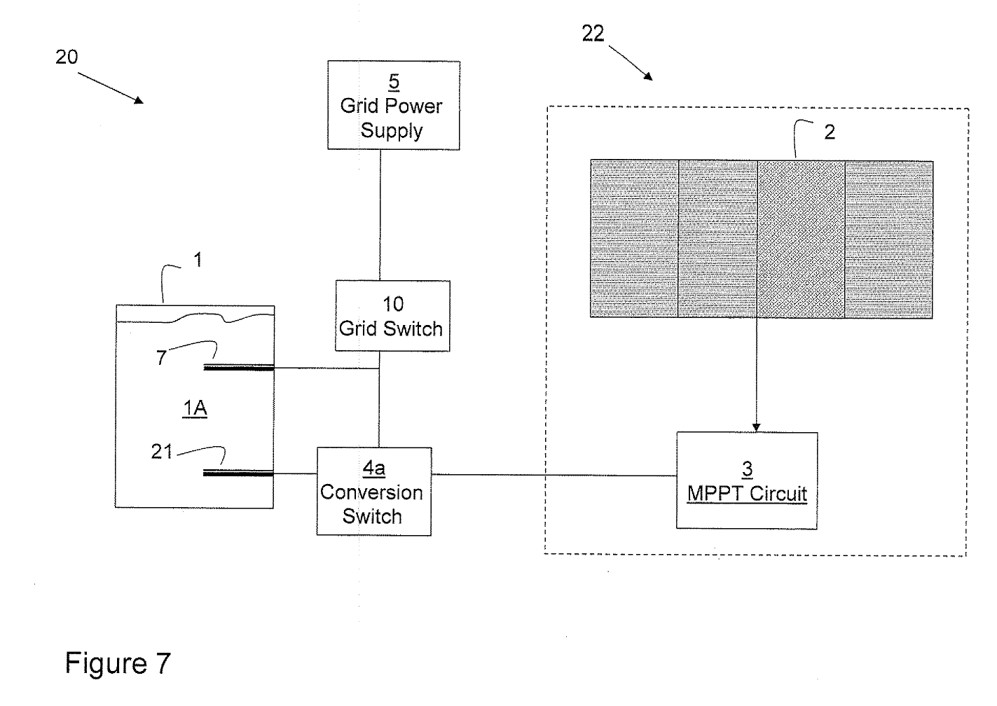

FIG. 6 depicts a system essentially identical to the system of FIG. 5 with the addition of an auxiliary heater 7 connected to gridded AC power supply 5 in a non-limiting preferred embodiment. Auxiliary heater 7 is connected or disconnected to gridded AC power supply by way of grid switch 10 in the various switching methods described above. Alternatively, it should be appreciated that auxiliary heating concurrent with PV heating is also included within the scope of the invention. Furthermore, the scope of the present invention includes a conversion switch 4a configured to entirely disconnect primary heating element 21 from PV power system 22 thereby transforming the water heater 1 into a conventional, AC grid powered heater as shown in FIG. 7. It should be appreciated that DC electrical grids are also included within the scope of the present invention. It should be noted that any embodiment employing PV or grid power, either simultaneously or alternatively is considered to be a hybrid heater for the sake of this document.

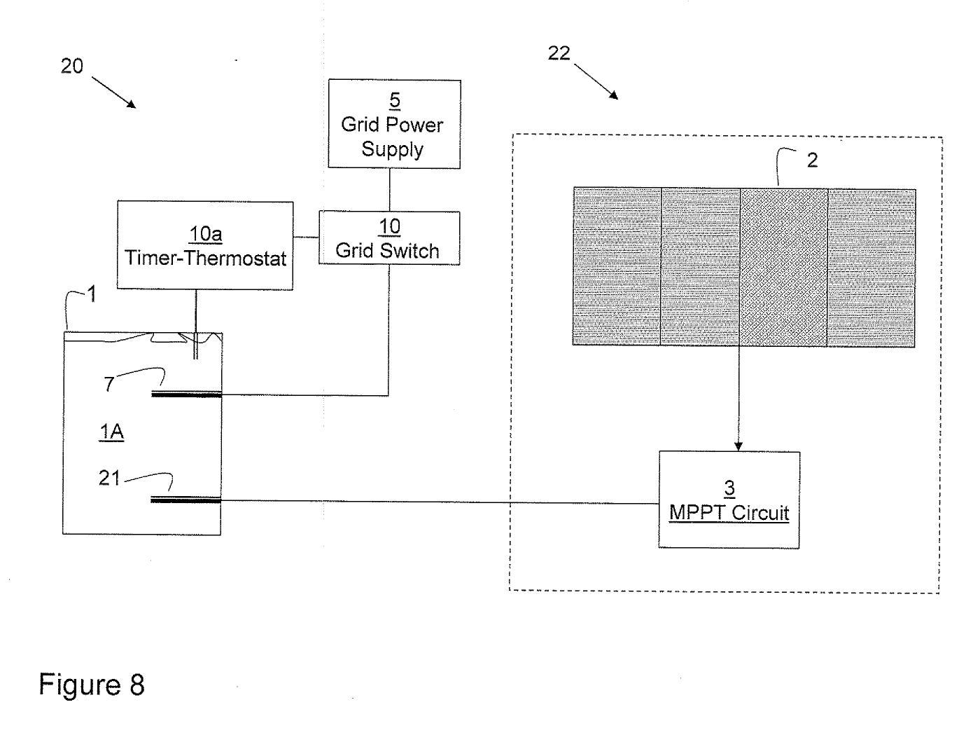

FIG. 8 depicts a hybrid heater in which grid switch 10 is actuated by way of a timer-thermostat 10a configured to be activated at a time selected by a user. Upon activation, timer-thermostat 10a measures the temperature of medium 1a, and if the temperature is below a preset temperature, actuates grid switch 10 to couple auxiliary heating element 7 with electric grid 5 as noted above. It should be appreciated that any combination of any of the above-described features is included within the scope of the present invention.

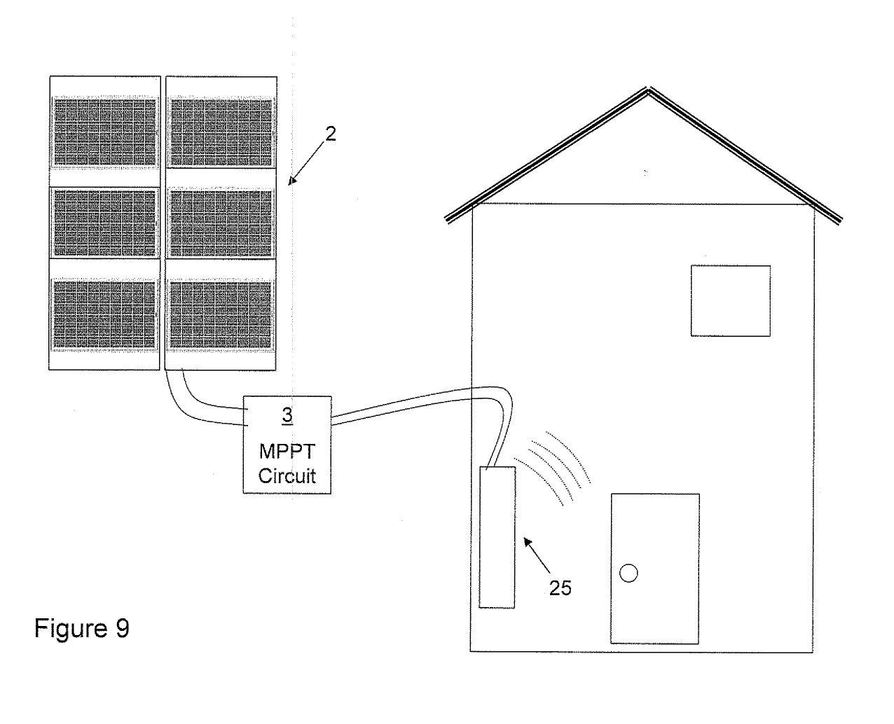

FIG. 9 depicts an additional system of the present invention configured to power a radiator 23 disposed inside a home. It should be appreciated that that the present invention is capable of powering any resistance heating device.

It should be noted that the present invention is highly efficient, light weight, simple to install and to manage, and inexpensive.

It will be appreciated that the above descriptions are intended only to serve as examples, and that many other embodiments are possible within the scope of the present invention as defined in the appended claims.

What is claimed is:

1. A photovoltaic heater responsive to fluctuations in incident solar radiation intensity comprising:
(a) a photovoltaic cell array;
(b) at least one primary heating element; and
(c) a maximum power point tracking circuit configured to track a point of maximum power of said photovoltaic cell array and to provide said maximum power collectively to said at least one heating element.

2. The photovoltaic heater of claim 1, further comprising:
(d) a medium wherein said at least one heating element is at least partly immersed in order to heat said medium.

3. The photovoltaic heater of claim 2, wherein said medium is selected from the group consisting of oil, water, and air.

4. The photovoltaic heater of claim 1, further comprising:
(d) a switch mechanism configured to reversibly connect said heating element to an electric power grid and to reversibly disconnect said heating element from said photovoltaic cell array.

5. The photovoltaic heater of claim 1, further comprising:
(d) an auxiliary heating element; and
(e) a grid switch, said grid switch configured to reversibly couple said auxiliary heating element to an electric power grid to supplement heating by said at least one primary heating element.

6. The photovoltaic heater of claim 5, further comprising:
(f) a conversion switch in operational connection with said grid switch, said conversion switch configured to reversibly disconnect said primary heating element from said maximum power point tracking circuit when said auxiliary heating element is coupled to the electric power grid, thereby converting said photovoltaic heater into a conventional heater.

7. The photovoltaic heater of claim 1, wherein said maximum power point tracking circuit includes circuitry to convert DC current to AC current.

8. A method of photovoltaic heating comprising:
(a) tracking a point of maximum power of a photovoltaic cell array; and
(b) driving a heating element at substantially said maximum power.

9. The method of claim 8, further comprising the step of:
(c) immersing at least a portion of said heating element in a medium to heat said medium.

10. The method of claim 9, wherein said medium is selected from the group consisting of oil, water, and air.

11. A hybrid heating system comprising:
(a) a medium to be heated;
(b) a solar powered heating element at least partially submerged in said medium;
(c) a photovoltaic power system operationally connected to said solar powered heating element and including:
(i) a photovoltaic cell array, and
(ii) a maximum power point tracking circuit configured to track a point of maximum power of said array and to provide said power to said solar powered heating element;
(d) a grid powered heating element at least partially submerged in said medium; and
(e) a grid switch for reversibly connecting said grid powered heating element to an electric power grid.

12. The hybrid heating system of claim 11, further comprising
(f) a timer-activated thermostat configured to actuate said grid switch at a selectable time when a temperature of said medium is less than a predefined temperature, thereby automatically augmenting heating of said medium by said solar powered heating element to obtain a desired temperature.
